(19) United States
(12) Patent Application Publication
(10) Pub. No.: US 2023/0108666 A1
(43) Pub. Date: Apr. 6, 2023

(54) ELECTROMAGNETIC RADIATION RESISTANT DOOR SYSTEM

(71) Applicant: Rob J. Evans, Glendale, AZ (US)

(72) Inventor: Rob J. Evans, Glendale, AZ (US)

(21) Appl. No.: 17/494,833

(22) Filed: Oct. 6, 2021

(51) Int. Cl. E06B 7/28; E06B 3/48; E06B 9/24

(52) U.S. Cl. CPC E06B 7/28; E06B 3/485; E06B 9/24; E06B 3/70

(57) ABSTRACT

An electromagnetic radiation (EMR) resistant door system is disclosed herein. The EMR door system comprises a shutter door, and at least one conducting substrate disposed on and extending along the height of the shutter door in a manner that the conducting substrate is facilitated to move in accordance with the movement of the shutter door. The EMR-resistant door system further comprises at least one conducting wire connected to the at least one conducting substrate attached to the shutter door along the entire length of the at least one conducting substrate on the shutter door, the at least one conducting wire linked to ground, thereby forming an electrical conduit from a top end of the shutter door to a bottom end of the shutter door, wherein the electrical conduit is connected to a permanent ground.

### TECHNICAL FIELD

The present disclosure relates to door systems in general. In particular, the present disclosure relates to a door system that is resistant to electromagnetic radiation, thereby protecting the occupants from undesired electromagnetic fields.

### BACKGROUND

Health concerns about the serious health effects of electromagnetic radiation have been raised. Research indicates that although the electromagnetic radiation that most humans typically encounter is non-ionizing and does not break apart DNA bonds, high frequency radio radiation, such as those used in 5G networks, does produce heat, which may damage cells. The World Health Organizations (WHO) has classified all radio frequency radiation as “possibly carcinogenic.” Furthermore, animal studies undertaken by the United States Department of Health have indicated links between exposure to high doses of radio frequency radiation and cancerous tumors. In addition to the risk of cancer, there are also other research that indicate that electromagnetic radiation may cause neurological damage as well as damage to the reproductive system.

### SUMMARY

The present disclosure envisages an electromagnetic radiation (EMR) resistant door system. The EMR door system comprises a shutter door, and at least one conducting substrate disposed on and extending along the height of the shutter door in a manner that the conducting substrate is facilitated to move in accordance with the movement of the shutter door. The EMR door system further comprises at least one conducting wire connected to the at least one conducting substrate attached to the shutter door along the entire length of the at least one conducting substrate on the shutter door, the at least one conducting wire linked to ground, thereby forming an electrical conduit from a top end of the shutter door to a bottom end of the shutter door, wherein the electrical conduit is connected to a permanent ground.

In a non-limiting alternative embodiment, the shutter door comprises a plurality of door panels, wherein the door panels are hingeably coupled to each other.

In a non-limiting alternative embodiment, each door panel includes one discreet conducting substrate disposed thereon, wherein the conducting substrate comprises hinge brackets extending therefrom for accommodating a hingepin for facilitating hingeable coupling of the door panels.

In a non-limiting alternative embodiment, one conducting wire is connected to each one discreet conducting substrate on two adjacent door panels, thereby forming conducting loops connecting two adjacent conducting substrates along the length of the shutter door.

In a non-limiting alternative embodiment, the conducting substrate is a metallic plate, and the conducting wire is a metallic wire.

In a non-limiting alternative embodiment, the shutter door is one of a shiplap door, a slatted door, a stackable slab roll, or a tongue and groove door.

In a non-limiting alternative embodiment, the shutter door is at least one of a manually operated door, a spring-operated door, and an electrically operated door.

### BRIEF DESCRIPTION OF THE DRAWINGS

FIG. 1 illustrates a perspective view of a conventional door system for garages and the like.

FIG. 2 illustrates a perspective view of an example electromagnetic radiation (EMR) resistant door system, according to an embodiment of the present disclosure.

FIG. 3 illustrates an enlarged perspective view of a portion of the EMR-resistant door system.

FIG. 4 illustrates another enlarged perspective view of a portion of the EMR-resistant door system.

FIG. 5 illustrates a schematic view of a grounding element used in the EMR-resistant door system.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

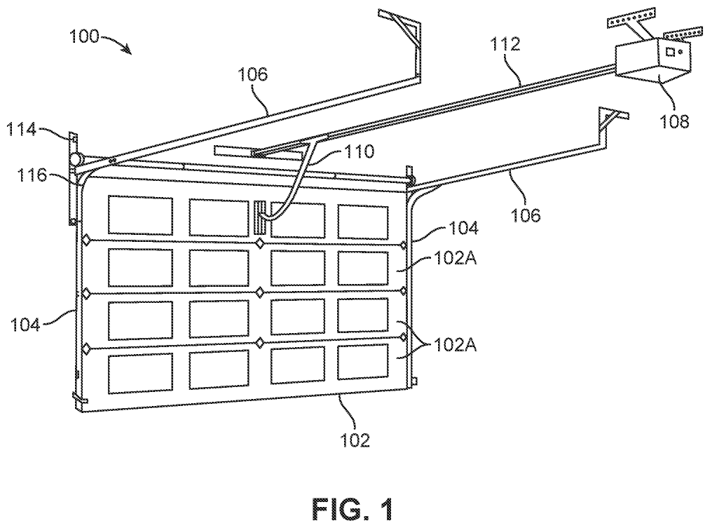

Referring to FIG. 1, a perspective view of a conventional door system 100 (herein interchangeably referred to as door system 100) for garages and the like, is illustrated. The door system 100 comprises a shutter door 102. As seen in FIG. 1, the shutter door 102 includes a plurality of door panels 102A. The door panels 102A are hingeably connected to each other for facilitating the relative movement between the door panels 102A when the shutter door 102 is to be opened. More specifically, a pair of vertical door tracks 104 and a pair of horizontal door tracks 106 accommodate the shutter door 102 therebetween. When the shutter door 102 is required to be opened, instructions for the same are received by an operator 108. The operator 108 is coupled to a J bracket 110 mounted on a trolly track 112. The operator 108, assisted by a torsion spring or the like, triggers the movement of the J bracket 110 in a upward direction when the shutter door 102 is required to be opened. One end of the J bracket 110 is coupled to the shutter door 102 for facilitating the displacement of the shutter door 102 along the vertical and horizontal door tracks 104, 106.

A disadvantageous aspect of the conventional door system 100 is that while it serves as a barrier for tangible objects, electromagnetic radiation (EMR) may still pass through the door system 100. The health concerns of exposure to electromagnetic radiations have already been discussed in the present disclosure. To overcome the aforementioned disadvantageous aspects of the conventional door system, the present disclosure envisages an electromagnetic radiation resistant door system.

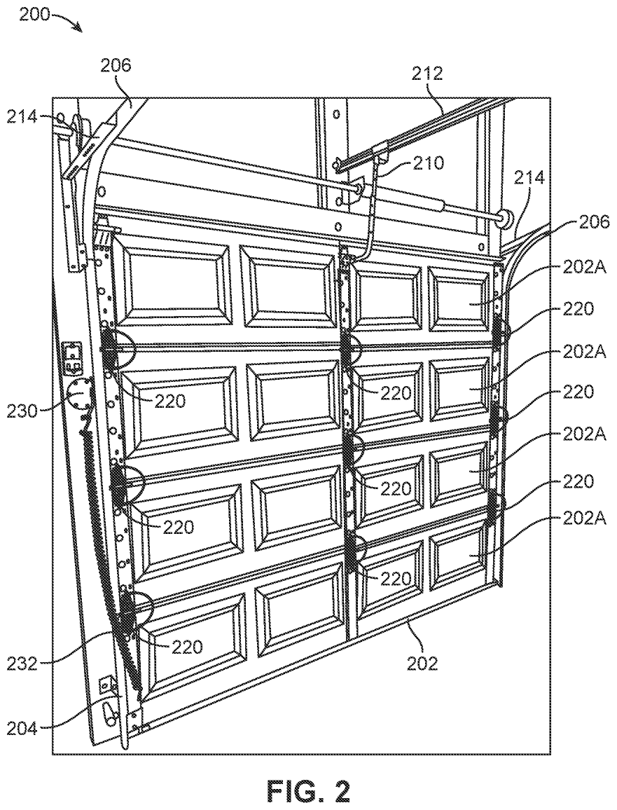

Referring to FIG. 2, a perspective view of an electromagnetic radiation (EMR)-resistant door system 200 (hereinafter referred to as door system 200), according to an embodiment of the present disclosure, is illustrated. The door system 200 comprises a shutter door 202. As seen in FIG. 2, the shutter door 202 includes a plurality of door panels 202A. The door panels 202A are hingeably connected to each other for facilitating the relative movement between the door panels 202A when the shutter door 202 is to be opened. More specifically, a pair of vertical door tracks 204 and a pair of horizontal door tracks 206 accommodate the shutter door 202 therebetween. When the shutter door 202 is required to be opened, instructions for the same are received by an operator (not shown in FIG. 2). The operator is coupled to a J bracket 210 mounted on a trolly track 212. The operator triggers the movement of the J bracket 210 in a rearward direction along the trolly track 212 when the shutter door 202 is required to be opened. One end of the J bracket 210 is coupled to the shutter door 202 for facilitating the displacement of the shutter door 202 along the vertical and horizontal door tracks 204, 206.

A flag bracket 214 facilitates the provision of a smooth track from the vertical door track 204 to the horizontal door track 206 to allow a smooth transition from an open position of the shutter door 202 to the closed position and vice versa. In accordance with an embodiment of the present subject matter, the door system 200 further comprises one or more door grounding assemblies 220. Grounding the shutter door 202 gives rise to an umbrella effect phenomenon of earthing. Studies have shown that the “umbrella” effect of earthing or grounding a body causes the potential of the grounded body to be the same as that of the Earth's electric potential, and such a grounded body therefore becomes an extension of the Earth's gigantic electric system. As such, the Earth's potential thus becomes the working agent that cancels, reduces, or pushes away electric fields from the grounded body. Therefore, grounding the shutter door 202 facilitates provision of an electromagnetic radiation resistance to the shutter door 202, thereby protecting the occupants from undesired electromagnetic fields.

In accordance with an embodiment of the present disclosure, the door grounding assemblies 220 are configured in a distributed manner on entire surface area the shutter door 202 to ensure that entire surface area of the shutter door 202 is grounded.

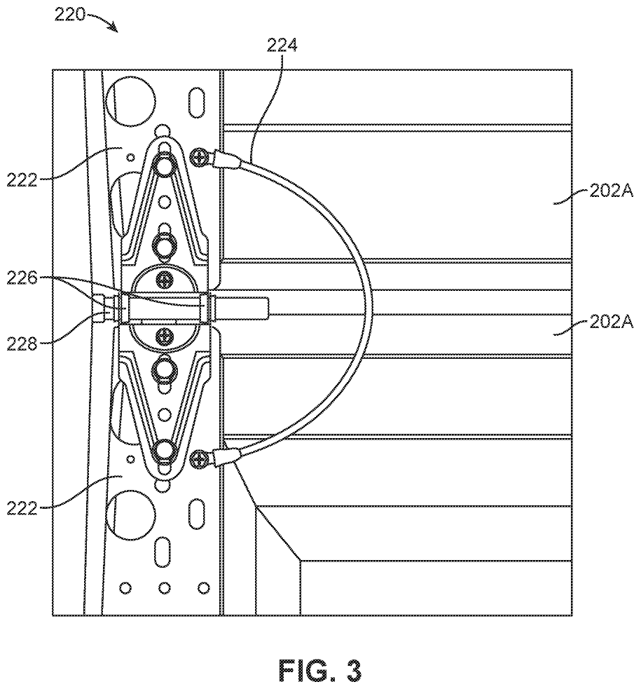

Referring to FIG. 3, an enlarged perspective view of a portion of the Electromagnetic Radiation (EMR) resistant door system 200 depicting the door grounding assembly 220, according to a first embodiment of the present disclosure, is illustrated. The grounding assembly 220 comprises at least one conducting substrate 222 disposed on and extending along the height of the shutter door 202 in a manner that the conducting substrate is facilitated to move in accordance with the movement of the shutter door 202. More specifically, in the instant embodiment, the shutter door 202 includes the door panels 202A that are hingeably connected to each other. The door panels 202A are required to have a provision of facilitating relative motion between them because as the shutter door 202 is lifted to be opened, the shutter door 202 has to transition from being accommodated in vertical door tracks to being accommodated in the horizontal door tracks. As such, in accordance with one implementation, each door panel 202A may have one elongate conducting substrate 222 that extends along the entire height of the door panel 202A. In one embodiment, the conducting substrate 222 may be an elongate metallic plate.

The grounding assembly 220 further comprises at least one conducting wire 224 connected to the at least one conducting substrate 222 attached to the shutter door 202 along the entire length of the at least one conducting substrate 222 on the shutter door 202. More specifically, each door panel 202A may include one conducting substrate 222, and a conducting wire 224 connects to the two conducting substrates 222 attached to adjacent door panels 202A of the shutter door 202. One conducting wire 224 is connected to each one discreet conducting substrate 222 on two adjacent door panels 202A, thereby forming conducting loops connecting two adjacent conducting substrates 222 along the length of the shutter door 202. As such, each panel 202A of the shutter door 202 is electrically connected to the adjacent door panel 202A via the conducting substrate 222 and the conducting wire 224. The formation of conducting loops ensures that the any relative movement between the door panels 202A does not disrupt the grounding assembly 220 by causing any tugging or accidental pulling thereof. The conducting wire 224 may be a metallic wire in accordance with one exemplary embodiment. In one embodiment, the conducting substrate 222 comprises hinge brackets 226 extending therefrom for accommodating a hingepin 228 for facilitating hingeable coupling of the door panels 202A.

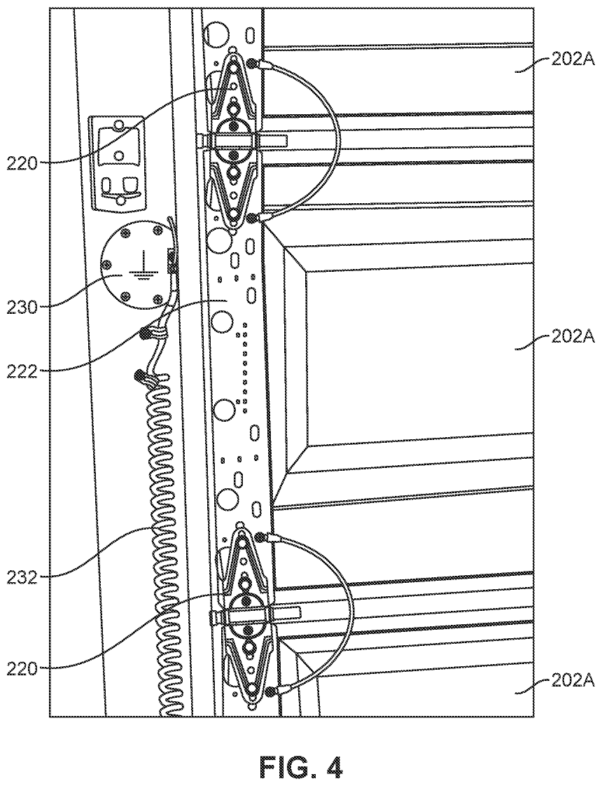

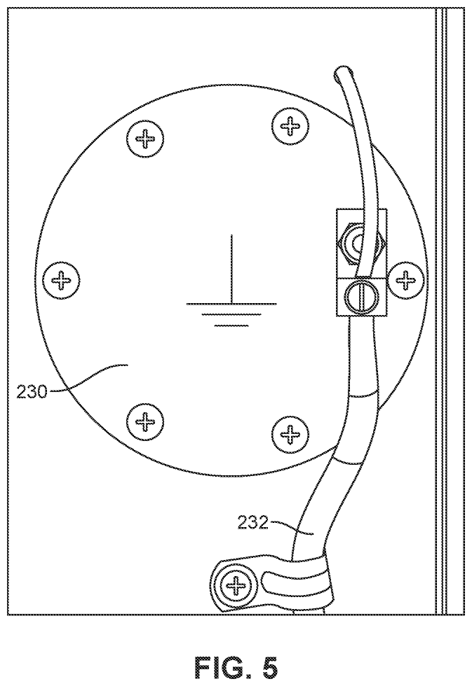

Referring to FIG. 4, another enlarged perspective view of a portion of the door system 200, according to a first embodiment of the present disclosure, is illustrated. Referring now to FIG. 2 and FIG. 4, one of the conducting substrates 222 may be connected to a grounding element 230 via a conducting wire 232. In one embodiment, the grounding element 230 may be ground bar that may be connected to a ground pole installed outside a domestic setup. The conducting wire 232 is linked to ground, thereby forms an electrical conduit from a top end of the shutter door 202 to a bottom end of the shutter door 202, wherein the electrical conduit is connected to a permanent ground. FIG. 5 illustrates a schematic view of the grounding element 230 used in the EMR-resistant door system, according to a first embodiment of the present subject matter.

It is to be noted that one shutter door 202 may include more than two such arrays of conducting substrates extending along the height of the shutter door. In the instant embodiment, as seen in FIG. 2, three arrays of conducting substrates are provided on the shutter door to ensure that the entire surface area of the shutter door is optimally grounded.

In the present disclosure, the shutter door 202 is a typical garage door having the grounding assembly 220 installed thereon. However, it is to be noted that the grounding assembly 220 can also be installed on other kinds of doors, including but not limited to, a shiplap door, a slatted door, a stackable slab roll, or a tongue and groove door, without deviating away from the inventive concept of the present subject matter. Furthermore, the door may be one of a manually operated door, a spring-operated door, and an electrically operated door. According to one aspect, the door may be an insulated door or a non-insulated door.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An electromagnetic radiation (EMR) resistant door system comprising:
a shutter door;
at least one conducting substrate disposed on and extending along the height of the shutter door in a manner that the conducting substrate is facilitated to move in accordance with the movement of the shutter door; and
at least one conducting wire connected to the at least one conducting substrate attached to the shutter door along the entire length of the at least one conducting substrate on the shutter door, the at least one conducting wire linked to ground, thereby forming an electrical conduit from a top end of the shutter door to a bottom end of the shutter door, wherein the electrical conduit is connected to a permanent ground.

2. The EMR-resistant door system according to claim 1, wherein the shutter door comprises a plurality of door panels, wherein the door panels are hingeably coupled to each other.

3. The EMR-resistant door system according to claim 2, wherein each door panel includes one discreet conducting substrate disposed thereon, wherein the conducting substrate comprises hinge brackets extending therefrom for accommodating a hingpin for facilitating hingeable coupling of the door panels.

4. The EMR-resistant door system according to claim 3, wherein one conducting wire is connected to each one discreet conducting substrate on two adjacent door panels, thereby forming conducting loops connecting two adjacent conducting substrates along the length of the shutter door.

5. The EMR-resistant door system according to claim 4, wherein the conducting substrate is a metallic plate, and the conducting wire is a metallic wire.

6. The EMR-resistant door system according to claim 1, wherein the shutter door is one of a shiplap door, a slatted door, a stackable slab roll, or a tongue and groove door.

7. The EMR-resistant door system according to claim 1, wherein the shutter door is at least one of a manually operated door, a spring-operated door, and an electrically operated door.
